(19) United States
(12) Patent Application Publication
(10) Pub. No.: US 2017/0192234 A1
(43) Pub. Date: Jul. 6, 2017

(54) HEAD-UP DISPLAY

(71) Applicant: LITE-ON TECHNOLOGY CORP., Taipei (TW)

(72) Inventor: MING-PING LAI, TAIPEI (TW)

(21) Appl. No.: 15/272,866

(22) Filed: Sep. 22, 2016

(30) Foreign Application Priority Data
Dec. 30, 2015 (CN) 201511025037.0

(51) Int. Cl. G02B 27/01

(52) U.S. Cl. CPC G02B 27/0149; G02B 27/0101; G02B 2027/0159; G02B 2027/0161

(57) ABSTRACT

A head-up display adapted for use with a windshield or a flat combiner includes an image-generating unit, a curved mirror and a concave mirror. The image-generating unit is operable to generate a light image propagating along a first optical path. The curved mirror is arranged downstream of the first optical path to form a first reflected light image propagating along a second optical path. The concave mirror is arranged downstream of the second optical path to form a second reflected light image propagating along a third optical path to be reflected onto the windshield or the flat combiner. The third optical path extends inclinedly relative to the second optical path and intersects with the first optical path.

### CROSS-REFERENCE TO RELATED APPLICATION

This application claims priority of Chinese Patent Application No. 201511025037.0, filed on Dec. 30, 2015.

### FIELD

The disclosure relates to a display device, and more particularly to a head-up display.

### BACKGROUND

A vehicle that incorporates head-up display (HUD) technology allows the driver to acquire important information therefrom while driving the vehicle without having to lower his/her head.

A conventional head-up display usually includes an image-generating unit, and a plurality of concave/convex mirrors for magnifying images generated from the image-generating unit and for compensating for optical aberration of the images. Currently, the head-up displays can be classified into two types, namely windshield type HUDs and combiner type HUDs.

As for the windshield type HUDs, the images generated by the image-generating unit are reflected onto a windshield of the vehicle sequentially via the concave/convex mirrors. In order to have clear and magnified images reflected onto the windshield, calibration of the concave/convex mirrors with respect to curvatures of the windshield is thus needed. However, huge assembly tolerances of windshields may still be found across different vehicles of the same type. That is to say, calibration of the concave/convex mirrors with regards to a respective windshield needs to be performed on each vehicle, which results in additional assembly time and costs. Moreover, in order to reflect the images onto certain positions of the windshield so that they can be close enough to the user, a relatively long object distance therefor has to be provided, and therefore the volume of the conventional windshield type HUDs cannot be reduced.

As for the combiner type HUDs, an additional combiner screen is provided, on which the image generated by the image-generating unit is reflected. Conventionally, the combiner screen is configured to be a concave mirror, so as to reduce the number of the concave/convex mirrors used in the combiner type HUDs and thus to effectively reduce the volume of the combiner type HUDs. However, the combiner with a curved screen is difficult to manufacture and results in relatively high production costs. Moreover, distortion of the images may occur when the combiner is poorly manufactured.

In view of the foregoing, each type of the conventional HUDs has corresponding disadvantages. In addition, for the windshield type HUDs, an angle between the windshield and a horizontal line of sight of a driver usually ranges from 25° to 35°, whereas an angle between the horizontal line of sight of the driver and the combiner for the combiner type HUDs usually ranges from 60° to 70°. Such difference restricts each type of the HUDs from being interchangeable. Therefore, effectively reducing the volume of the HUDs and the manufacturing costs, and allowing images to be reflected on both the windshield and the combiner, have become tasks for skilled artisans in the related field.

### SUMMARY

Therefore, an object of the disclosure is to provide a head-up display that can alleviate at least one of the drawbacks of the prior art.

According to the disclosure, a head-up display that is adapted for use with one of a windshield of a vehicle and a flat combiner by a user may include an image-generating unit, a curved mirror and a concave mirror.

The image-generating unit is operable to generate a light image propagating along a first optical path.

The curved mirror is arranged downstream of the first optical path for reflecting the light image incident from the image-generating unit so as to form a first reflected light image which propagates along a second optical path that extends inclinedly relative to the first optical path.

The concave mirror is arranged downstream of the second optical path for reflecting the first reflected light image so as to forma second reflected light image which propagates along a third optical path to be reflected onto the one of the windshield of the vehicle and the flat combiner. The third optical path extends inclinedly relative to the second optical path and intersects with the first optical path.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram illustrating one embodiment of a head-up display used with a windshield according to the disclosure;

FIG. 2 is a schematic diagram of the embodiment illustrating that the head-up display is used with a flat combiner;

FIG. 3 is a partly schematic diagram of the embodiment of FIG. 1 illustrating another embodiment of the head-up display used with the windshield;

FIG. 4 is a partly schematic diagram of the embodiment of FIG. 2 illustrating another embodiment of the head-up display used with the flat combiner;

FIG. 5 is another schematic diagram of the embodiment, illustrating the relationship between a first optical path, a second optical path and a third optical path, where the head-up display can be used with a windshield of a vehicle or a flat combiner;

FIG. 6 is a schematic diagram of yet another embodiment, illustrating that a concave mirror of the head-up display is rotatable when the head-up display is used with the windshield; and

FIG. 7 is a schematic diagram of yet another embodiment, illustrating that the combiner and the concave mirror are rotatable when the head-up display is used with the flat combiner.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

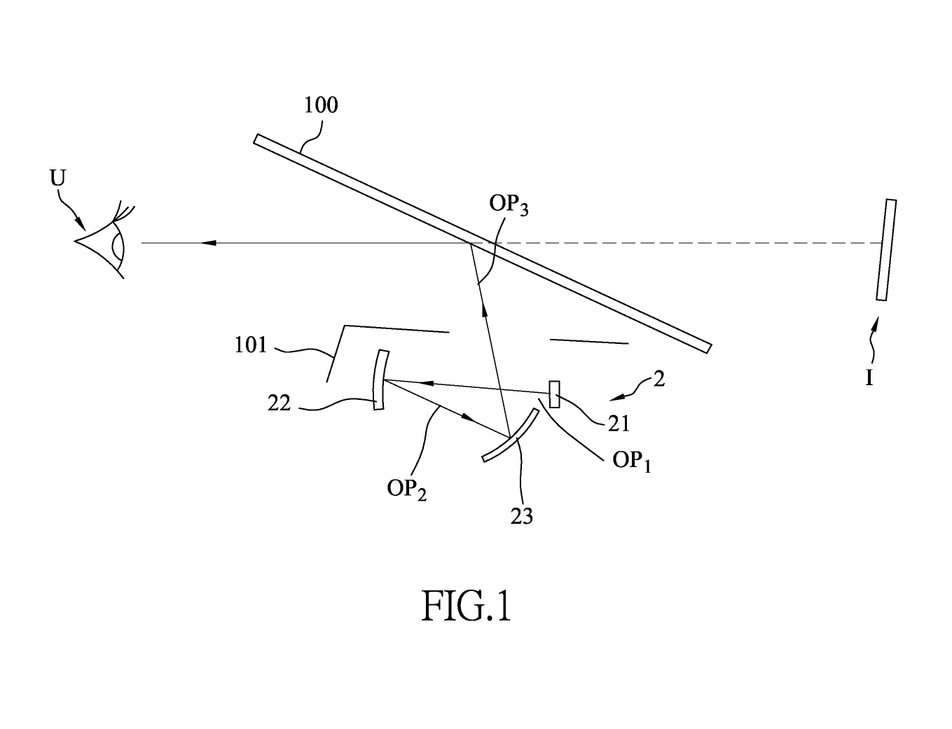

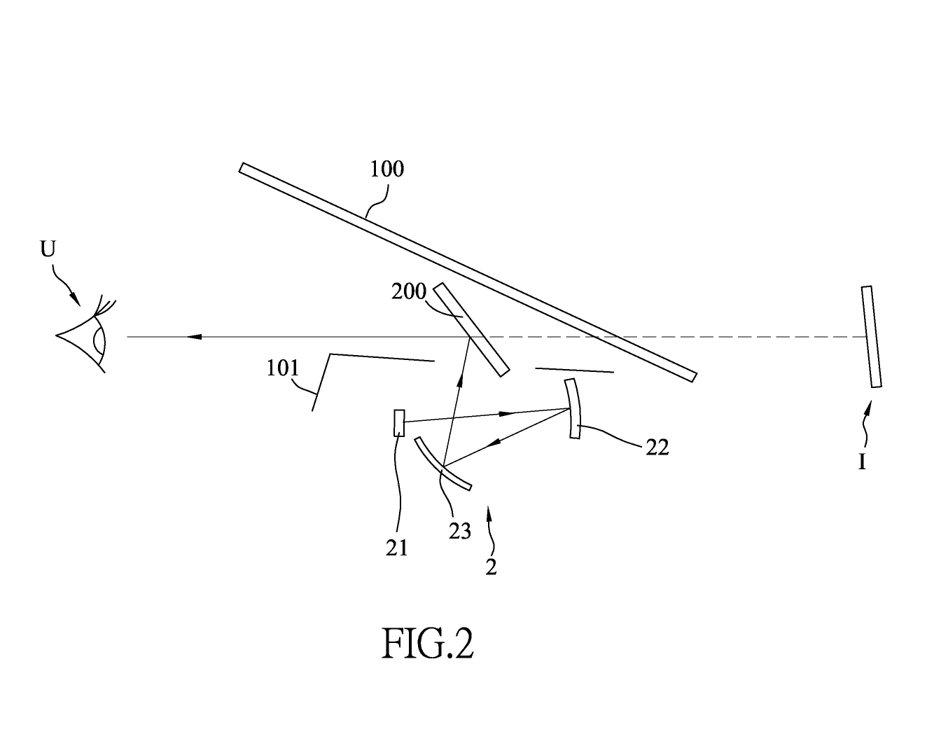

Referring to FIGS. 1 and 2, one embodiment of a head-up display 2 according to the present disclosure is adapted for use with a windshield 100 of a vehicle or a flat combiner 200, is mounted below a dashboard platform 101 of the vehicle, and includes an image-generating unit 21, a curved mirror 22 and a concave mirror 23.

The image-generating unit 21 is operable to generate a light image propagating along a first optical path OP₁. The curved mirror 22 is arranged downstream of the first optical path OP₁ for reflecting the light image incident from the image-generating unit 21 so as to generate a first reflected light image that propagates along a second optical path OP₂. The concave mirror 23 is arranged downstream of the second optical path OP₂ for reflecting the first reflected light image, so as to generate a second reflected light image that propagates along a third optical path OP₃ and reflects away from the head-up display 2. As illustrated in FIG. 1, the second optical path OP₂ extends inclinedly relative to the first optical path OP₁ at an angle, and the third optical path OP₃ extends inclinedly relative to the second optical path OP₂ at an angle and intersects with the first optical path OP₁. Specifically, as illustrated in FIG. 1, the first optical path OP₁ extends from a position adjacent to the dashboard platform 101 toward the curved mirror 22, and the second optical path OP₂ extends in a direction that is away from the dashboard platform 101 toward the concave mirror 23. In certain embodiments, the image-generating unit 21 may be a liquid-crystal display (LCD), a Liquid-Crystal-On-Silicon (LCOS) display, a vacuum fluorescent display (VFD), a Digital Light Processing (DLP) display, or a laser scanning MEMS.

In certain embodiments, the image-generating unit 21 and the curved mirror 22 are disposed closer to the dashboard platform 101 relative to the concave mirror 23, and the concave mirror 23 is disposed farther away from the dashboard platform 101 and between the image generating unit 21 and the curved mirror 22. In greater detail, a distance from a horizontal line of sight of a user (U) respectively to either the image-generating unit 21 or the curved mirror 22 is smaller than a distance from the horizontal line of sight of the user to the concave mirror 23. It is worth noting that, when the head-up display 2 is adapted for use with the windshield 100 of the vehicle, i.e., to reflect the second reflected light image onto the windshield 100 for generating a virtual image (I), the curved mirror 22 is disposed closer to the user (U) relative to the image-generating unit 21 and the concave mirror 23. On the other hand, when the head-up display 2 is adapted for use with the flat combiner 200, i.e., to reflect the second reflected light image onto the flat combiner 200, the curved mirror 22 is disposed farther away from the user (U) relative to the image-generating unit 21 and the concave mirror 23.

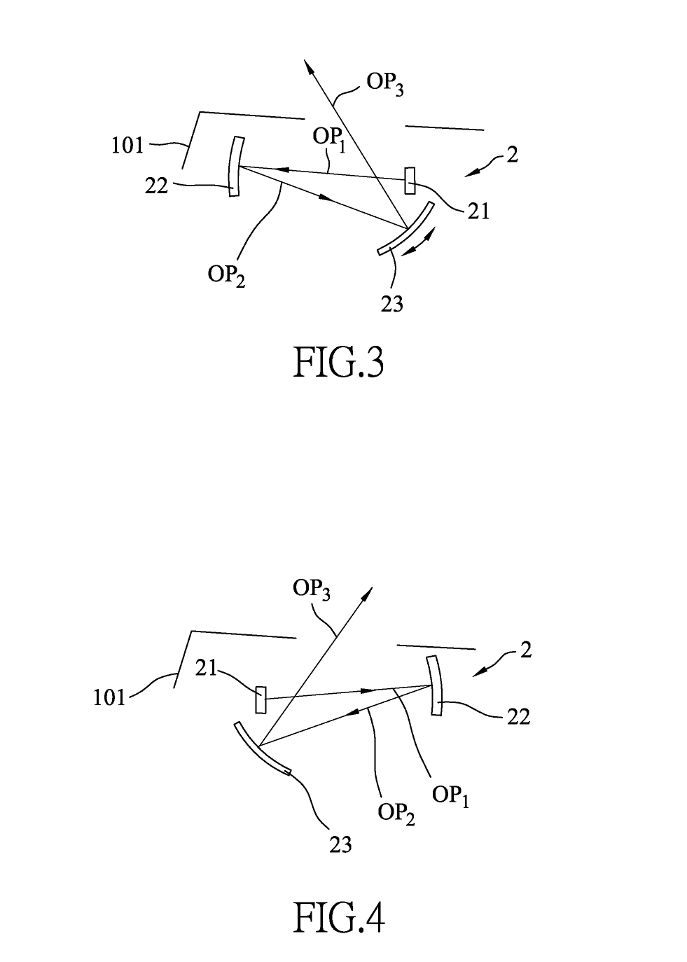

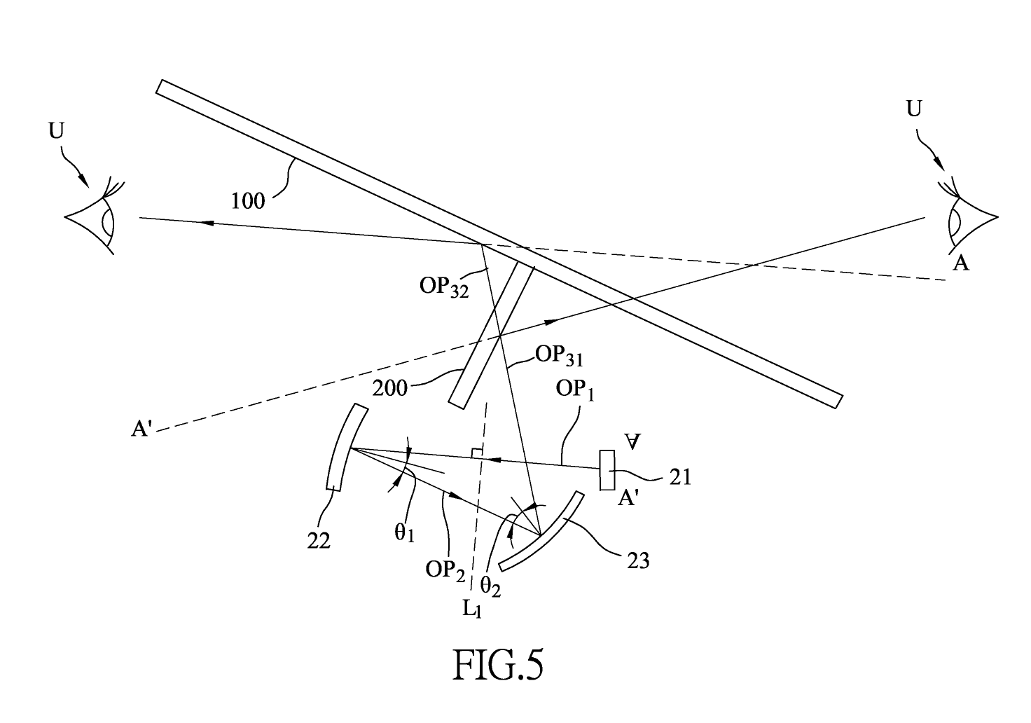

It is worth noting that, with reference to FIGS. 3 and 4, the position of the concave mirror 23 is not limited to what are disclosed in FIGS. 1 and 2. In certain embodiments, the concave mirror 23 may be disposed at one side of the image-generating unit 21 opposite to the curved mirror 22, without any other elements, e.g., the image-generating unit 21 and the curved mirror 22, being adjusted with respect to their positions. In addition, the image-generating unit 21, the curved mirror 22 and the concave mirror 23 may be disposed in a casing (not shown) which is mounted below the dashboard platform 101. Since the method of packing these optical elements in the casing is well known in the art, such method is omitted herein for the sake of brevity.

It is also worth noting that the utilization of the concave mirror 23 is for magnifying the first reflected light image and for generating the second reflected light image which propagates along the third optical path OP₃. However, to only include the concave mirror 23 in the head-up display 2 of the present disclosure may adversely result in image distortion and aberration. As such, by incorporating the curved mirror 22 into the head-up display of the present disclosure, the image distortion and aberration can be effectively compensated so as to allow a much clearer image to be reflected. The curved mirror 22 may be a concave mirror or a convex mirror, so long as the image distortion and aberration caused by the concave mirror 23 can be compensated. In this embodiment, the curved mirror 22 is a concave mirror, and a radius of curvature of the curved mirror 22, as well as of the concave mirror 23, can be adjusted based on actual demands such as image quality.

It should be noted that, except for adjusting the concave mirror 23 and the curved mirror 22, the image distortion and/or aberration may also be compensated for by adjusting the light image generated by the image-generating unit 21.

By allowing the third optical path OP₃ to intersect with the first optical path OP₁, the volume of the head-up display 2 according to the present disclosure can be effectively reduced. Moreover, the head-up display 2 of the present disclosure is suitable for both the windshield 100 and the flat combiner 200 in a same vehicle.

Generally speaking, the horizontal line of sight of the user (U) may intersect with the windshield 100 at an angle ranging from 25° to 35°, which is usually less than an angle formed between the horizontal line of sight of the user (U) and the flat combiner 200 (about 60° to 70°). Therefore, each type of the conventional head-up displays needs to be designed in accordance with such angle difference.

However, the head-up display 2 of the present disclosure can overcome such drawback without altering the infrastructure thereof. When the user (U) wishes to use the head-up display 2 with the flat combiner 200 (or the windshield 100) instead of the windshield 100 (or the flat combiner 200), he/she only needs to rotate the head-up display 2 by 180° relative to the user and tilt the head-up display 2 at a relatively small range in accordance with the position to be reflected on the flat combiner 200 (or the windshield 100).

Specifically, when the user (U) uses the head-up display 2 with the windshield 100 as illustrated in FIG. 1, the head-up display 2 may be mounted under the dashboard platform 101 in such a manner that the image-generating unit 21 is disposed farther away from the user in comparison to the curved mirror 22 and the concave mirror 23, and that the concave mirror 23 is disposed between the user (U) and the image-generating unit 21, so as to allow the second reflected light image to be reflected onto the windshield 100 and to generate the virtual image (I) behind the windshield 100.

On the other hand, when the user (U) uses the head-up display 2 with the flat combiner 200 as illustrated in FIG. 2, the user (U) only needs to rotate the head-up display 2 by 180°, such that the image-generating unit 21 is disposed closer to the user (U) in comparison to the curved mirror 22 and the concave mirror 23, and is disposed between the user (U) and the concave mirror 23. As such, the second reflected light image can propagate along the third optical path OP₃ so as to be reflected onto the flat combiner 200, which is located between the windshield 100 and the dashboard platform 101. In other words, by simply rotating the head-up display 2 of the present disclosure, the head-up display 2 is suitable for dual use with the windshield 100 and the flat combiner 200.

In greater detail, FIG. 5 illustrates that the head-up display 2 of the present disclosure is suitable for dual use with the windshield 100 and the flat combiner 200 by showing the relationship between the curved mirror 22 and the concave mirror 23. An imaginary line L₁ perpendicular to the first optical path OP₁ and located between the image-generating unit 21 and the curved mirror 22 is defined as illustrated in FIG. 5. The relative positions of the image-generating unit 21, the curved mirror 22 and the concave mirror 23 are fixed when the head-up display 2 is used with either the windshield 100 or the flat combiner 200. When the user (U) wants to switch the reflecting positions of the second reflected light image from the windshield 100 to the flat combiner 200 (or from the flat combiner 200 to the windshield 100), the head-up display 2 only needs to be rotated, so that the image-generating unit 21, the curved mirror 22 and the concave mirror 23 of the head-up display 2 can be placed at positions that are in mirror symmetry with their previous positions with respect to the imaginary line L₁.

Here, it may be worth noting that, by adjusting the image-generating unit 21, the curved mirror 22 and the concave mirror 23 of the head-up display 2, the second reflected light image to be reflected on the windshield 100 (or the flat combiner 200) may have a distortion ratio of lower than 2.5%, which cannot be discerned by the user (U). That is to say, the head-up display 2 of the present disclosure can reflect images on not only the windshield 100 with a curvature, but also on a flat screen (i.e., the flat combiner 200). The flat combiner 200 may be a semi-reflective planar mirror which, in comparison with the conventional curved screens, has relatively lower manufacturing costs and is relatively simpler for possible repair.

In certain embodiments, when the user (U) views the second reflected light image reflected on the windshield 100 of the vehicle (or the flat combiner 200), a distance from the eyes of the user (U) to the virtual image (I) of the second reflected light image formed behind the windshield 100 may be greater than 1.5 meters, so as to reduce the possibility for resulting in fatigue of crystalline lens of the user (U).

Referring back to FIG. 5, the second optical path OP₂ forms a first angle θ₁ with a normal line of the curved mirror 22, and a second angle θ₂ with a normal line of the concave mirror 23. By adjusting a ratio of the first angle θ₁ to the second angle θ₂, a minimum height of the head-up display 2, as well as minimum image aberration of the head-up display 2 according to the present disclosure can be achieved. In addition, the volume of the head-up display 2 can be reduced by adjusting the ratio of the first angle θ₁ to the second angle θ₂. In certain embodiments, the ratio of the first angle θ₁ to the second angle θ₂ may preferably range from 0.43 to 1.25.

In the embodiments where the head-up display 2 is used with the windshield 100, the light image (such as a first pattern (A) shown in FIG. 5) generated by the image-generating unit 21 may be inverted as illustrated in FIG. 5, so that an upright virtual image may thus be formed behind the windshield 100 after the second reflected light image propagates along the third optical path OP₃₂ and reflects on the windshield 100. In the embodiments where the head-up display 2 is used with the flat combiner 200, the light image (such as a second pattern (A′) in FIG. 5) generated by the image-generating unit 21 may be upright as illustrated in FIG. 5, so that an upright virtual image may be formed behind the flat combiner 200 after the second reflected light image propagates along the third optical path OP₃₁ and reflects on the flat combiner 200.

For illustrating the head-up display 2 of the present disclosure in a clearer manner, one example of the head-up display 2 according to the present disclosure is provided. Tables 1 and 2 respectively show the optical data of the head-up display 2 which is used with the windshield 100 and with the flat combiner 200 (after being rotated by 180°) along the optical path all the way from the image-generating unit 21 to the eye of the user.

TABLE 1

| | | | | Effective | |
|---|---|---|---|---|---|
| | Surface | Distance | | diameter | Tilt |
| Surface No. | Type/Radius | (mm) | Medium | (mm) | angle |
| Object | — | 0 | LCD(the image | 21.55 | — |
| | | | generating unit 21) | 408 | |
| 1 | — | −120 | Air | | — |
| 2 | Coordinate Break | — | reaches the curved | | 10.5* |
| | | | mirror 22 | | |
| 3 | Extended | 0 | the curved mirror | 80 | — |
| | Polynomial | | 22 | | |
| 4 | Coordinate Break | — | reflected by the | | 10.5* |
| | | | curved mirror 22 | | |
| 5 | — | 80 | Air | | — |
| 6 | Coordinate Break | — | reaches the concave | | 19* |
| | | | mirror 23 | | |
| 7 | Extended | 0 | the concave mirror | 80 | — |
| | Polynomial | | 23 | | |
| 8 | Coordinate Break | — | reflected by the | | 19* |
| | | | concave mirror 23 | | |
| 9 | — | −150 | Air | | — |
| 10 | Coordinate Break | — | reaches the | | 66* |
| | | | windshield 100 | | |
| 11 | 1.5E+004 | 0 | the windshield 100 | 90 | — |
| 12 | Coordinate Break | — | reflected by the | | 66* |
| | | | windshield | | |
| 13 | | 850 | Air | | — |
| 14/stop | infinity | | human eye | 6 | |
| 15 | infinity | −2000 | Air | | — |
| Image | Image | 0 | virtual image | 75 | — |

TABLE 2

| | | | | Effective | |
|---|---|---|---|---|---|
| | Surface | Distance | | diameter | Tilt |
| Surface No. | Type/Radius | (mm) | Medium | (mm) | angle |
| Object | — | 0 | LCD(the image | 21.55 | — |
| | | | generating unit 21) | 408 | |
| 1 | — | −120 | Air | | — |
| 2 | Coordinate Break | — | reaches the curved | | 10.5* |
| | | | mirror 22 | | |
| 3 | Extended | 0 | the curved mirror | 80 | — |
| | Polynomial | | 22 | | |
| 4 | Coordinate Break | — | reflected by the | | 10.5* |
| | | | curved mirror 22 | | |
| 5 | — | 80 | Air | | — |
| 6 | Coordinate Break | — | reaches the concave | | 19* |
| | | | mirror 23 | | |
| 7 | Extended | 0 | the concave mirror | 80 | — |
| | Polynomial | | 23 | | |
| 8 | Coordinate Break | — | reflected by the | | 19* |
| | | | concave mirror 23 | | |
| 9 | — | −120 | air | | — |
| 10 | Coordinate Break | — | reaches the flat | | −30* |
| | | | combiner 200 | | |
| 11 | Infinity | 0 | the flat combiner | 90 | — |
| | | | 200 | | |
| 12 | Coordinate Break | — | reflected by the | | −30* |
| | | | flat combiner 200 | | |
| 13 | | 850 | Air | | — |
| 14 | Infinity | | human eye | 6 | |
| (Stop) | | | | | |
| 15 | Infinity | −2000 | Air | | — |
| Image | Image | 0 | virtual image | 75 | — |

From the data shown above, the distance (mm) refers to the distances between two of the optical elements, the user (U) and the virtual image (I), where the sign (+ or −) indicates opposite directions. In this example, the distance from the image-generating unit 21 to the curved mirror 22 is 120 mm, and the distance from the curved mirror 22 to the concave mirror 23 is 80 mm.

In addition, the tilt angles recited in Tables 1 and 2 refer to the angles formed between one of the first, second and third optical paths OP₁, OP₂, OP₃ and one of the normal lines of the image-generating unit 21, the curved mirror 22, the concave mirror 23, and the windshield 100 (or the flat combiner 200). In this example, the angle formed between the second optical path OP₂ and the normal line of the curved mirror 22 (i.e., the first angle θ₁) is 10.5°, the angle formed between the second optical path OP₂ and the normal line of the concave mirror 23 (i.e., the second angle θ₂) is 19°, and the angle formed between the third optical path OP₃ and the normal line of the windshield 100 (or the flat combiner 200) is 66° (30°). The ratio of the first angle θ₁ to the second angle θ₂ in this example is 0.552.

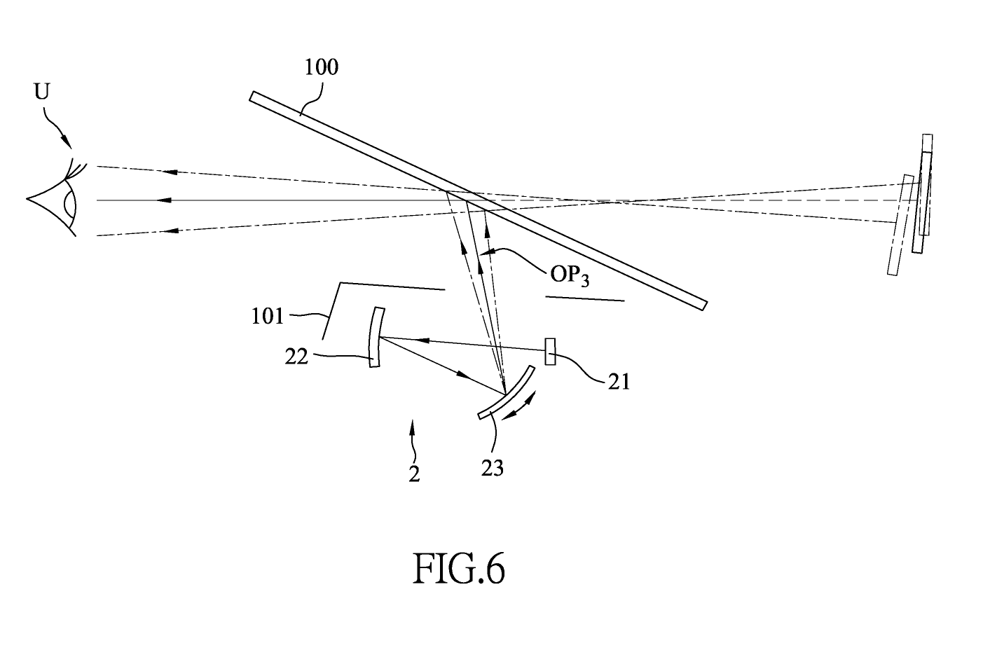

Referring to FIG. 6, in certain embodiments where the head-up display 2 is used with the windshield 100, the concave mirror 23 may be rotatable so as to alter the direction of the third optical path OP₃ in accordance with viewing angles of different users (U). As such, the portion of windshield 100 on which the second reflected light image is reflected can be altered for different users.

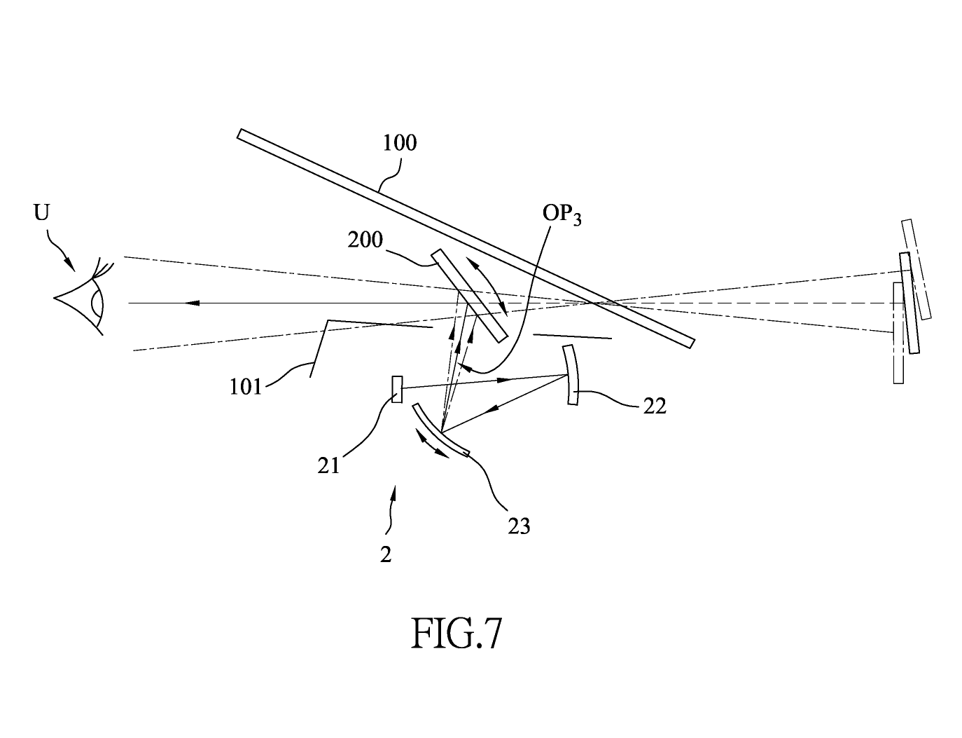

Similarly, in certain embodiments where the head-up display 2 is used with the flat combiner 200 as illustrated in FIG. 7, the concave mirror 23 may also be rotatable so as to alter the direction of the third optical path OP₃ and, thus, to alter the portion of the flat combiner 200 on which the second reflected light image is reflected. Moreover, aside from being fixedly mounted on the dashboard platform 101, the flat combiner 200 may also be movably or rotatably mounted to the dashboard platform 101. As such, the user (U) may adjust the flat combiner 200, instead of the concave mirror 23, based on the viewing angles thereof.

In summary, by configuring the distance from the horizontal line of sight of the user (U) respectively to either the image-generating unit 21 or the curved mirror 22 to be smaller than the distance from the horizontal line of sight of the user to the concave mirror 23, by disposing the curved mirror 22 to be closer the user (U) relative to the image-generating unit 21 and the concave mirror 23 when the head-up display 2 is for use with the windshield 100 of the vehicle, by disposing the curved mirror 22 to be farther away from the user (U) relative to the image-generating unit 21 and the concave mirror 23 when the head-up display 2 is for use with the flat combiner 200, by disposing the concave mirror 23 at one of two opposite sides of the image-generating unit 21, and/or by configuring the head-up display 2 of the present disclosure to have the first optical path OP₁ intersecting with the third optical path OP₃, the volume of the head-up display 2 can be effectively reduced. Moreover, the head-up display 2 is suitable for use with both the windshield 100 of the vehicle and the flat combiner 200. The user (U) may simply rotate the head-up display 2 by 180° without adjusting the infrastructure of the head-up display 2 (e.g., to alter the relative positions of the image-generating unit 21, the curved mirror 22 and the concave mirror 23), so as to switch the reflecting positions from one of the windshield 100 and the flat combiner 200 to the other. Furthermore, by adjusting the ratio of the first angle θ₁ to the second angle θ₂, the entire volume of the head-up display 2 can be further reduced.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A head-up display adapted for use with one of a windshield of a vehicle and a flat combiner by a user, said head-up display comprising:
an image-generating unit operable to generate a light image propagating along a first optical path;
a curved mirror arranged downstream of said first optical path for reflecting the light image incident from said image-generating unit so as to form a first reflected light image which propagates along a second optical path that extends inclinedly relative to said first optical path; and
a concave mirror arranged downstream of said second optical path for reflecting the first reflected light image so as to forma second reflected light image which propagates along a third optical path to be reflected onto the one of the windshield of the vehicle and the flat combiner, wherein said third optical path extends inclinedly relative to said second optical path and intersects with said first optical path.

2. The head-up display according to claim 1, wherein a distance from a horizontal line of sight of the user to each said image-generating unit and said curved mirror is smaller than a distance from the horizontal line of sight of the user to said concave mirror.

3. The head-up display according to claim 2, wherein said head-up display is adapted for use with the windshield of the vehicle, and said curved mirror is disposed closer to the user relative to said image-generating unit and said concave mirror.

4. The head-up display according to claim 2, wherein said head-up display is adapted for use with the flat combiner, and said curved mirror is disposed farther away from the user relative to said image-generating unit and said concave.

5. The head-up display according to claim 2, wherein said concave mirror is disposed between said image-generating unit and said curved mirror.

6. The head-up display according to claim 1, wherein said second optical path forms a first angle with a normal line of said curved mirror, and forms a second angle with a normal line of said concave mirror, a ratio of said first angle to said second angle ranging from 0.43 to 1.25.

7. The head-up display according to claim 3, wherein said curved mirror is disposed between said image-generating unit and the user.

8. The head-up display according to claim 4, wherein said image-generating unit is disposed between said curved mirror and the user.

9. The head-up display according to claim 2, wherein:
when said head-up display is adapted for use with the windshield, said image-generating unit, said curved mirror and said concave mirror are disposed at positions that are fixed relative to each other and that are respectively in mirror symmetry to positions of said image-generating unit, said curved mirror and said concave mirror with respect to an imaginary line when said head-up display is adapted for use with the flat combiner; and
the imaginary line is perpendicular to said first optical path and is located between said image-generating unit and said curved mirror.

10. The head-up display according to claim 9, wherein said concave mirror is rotatable based on a viewing angle of the user.
